(19) United States
(12) Patent Application Publication
(10) Pub. No.: US 2026/0329968 A1
(43) Pub. Date: Oct. 22, 2026

(54) METHOD OF OPERATING PROBABILITY INFERENCE APPARATUS AND PROBABILITY INFERENCE APPARATUS

(71) Applicant: SAMSUNG ELECTRONICS CO., LTD., Suwon-si (KR)

(72) Inventors: Paul OH, Suwon-si (KR); Seunghoon JEE, Suwon-si (KR); Chansol HWANG, Suwon-si (KR); Dokwan OH, Suwon-si (KR); Junhee LEE, Suwon-si (KR)

(73) Assignee: SAMSUNG ELECTRONICS CO., LTD., Suwon-si (KR)

(21) Appl. No.: 19/530,982

(22) Filed: Feb. 5, 2026

(30) Foreign Application Priority Data
Apr. 22, 2025 (KR) 10-2025-0052595
Jul. 31, 2025 (KR) 10-2025-0105464

(51) Int. Cl. G06F 17/18; G06F 7/544; G06N 3/048; G06N 3/09

(52) U.S. Cl. CPC G06F 17/18; G06F 7/5443; G06N 3/048; G06N 3/09

(57) ABSTRACT

A method of operating a probability inference apparatus is provided. The probability inference apparatus is configured to generate continuous output data corresponding to input data using a backbone neural network and infer a probability distribution corresponding to the input data by performing a multiply-accumulate (MAC) operation with positive output data of the backbone neural network using a positive parameter of an additional layer.

### CROSS-REFERENCE TO RELATED APPLICATIONS

This application is based on and claims priority from Korean Patent Application No. 10-2025-0052595, filed on Apr. 22, 2025, and Korean Patent Application No. 10-2025-0105464, filed on Jul. 31, 2025, in the Korean Intellectual Property Office, the entire disclosures of which are incorporated herein by reference for all purposes.

### BACKGROUND

### 1. Field

Methods and apparatuses consistent with embodiments of the disclosure relate to a method of operating a probability inference apparatus and the probability inference apparatus.

### 2. Description of the Related Art

Recently, neural networks are widely used in various artificial intelligence (AI) application fields to estimate (or predict) a probability distribution for input data. For example, in data compression, the neural network may be used to perform entropy encoding by estimating the probability of symbol appearance. In medical image analysis or object recognition, the neural network may be used to represent uncertainty of pixels or classes. Furthermore, the neural network may be used in reinforcement learning to make decisions based on the probability of selecting actions. Accordingly, estimation of the probability distribution is a key function of AI models, and the accuracy and efficiency may significantly impact performance of an entire system. However, related art probability estimation neural networks use exponential (exp) operations of activation functions such as softmax and sigmoid, to infer final probability values, which require large memory tables in LUT-based implementation. Therefore, related art probability estimation neural networks may have issues such as cache misses and memory bandwidth bottlenecks.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of the disclosure, there is provided a method of performing probability inference, the method including: receiving input data, generating, using a backbone neural network, continuous output data based on the input data, performing a multiply-accumulate (MAC) operation on positive output data of the backbone neural network using a positive parameter of an additional layer, and inferring a probability distribution corresponding to the input data based on a result of the MAC operation.

According to another aspect of the disclosure, there is provided a probability inference apparatus including: at least one memory; and at least one processor configured to: receive input data, generate, using a backbone neural network, continuous output data based on the input data, perform a multiply-accumulate (MAC) operation on positive output data of the backbone neural network using a positive parameter of an additional layer, and infer a probability distribution corresponding to the input data based on a result of the MAC operation, wherein the at least one memory is configured to store a parameter of the backbone neural network and the positive parameter of the additional layer.

According to another aspect of the disclosure, there is provided a non-transitory computer-readable storage medium storing instructions that, when executed by a processor, cause the processor to perform: receiving input data; generating, using a backbone neural network, continuous output data based on the input data; and performing a multiply-accumulate (MAC) operation on positive output data of the backbone neural network using a positive parameter of an additional layer; and inferring a probability distribution corresponding to the input data based on a result of the MAC operation.

Additional aspects of embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain embodiments with reference to the accompanying drawings, in which:

FIG. 1 is a block diagram illustrating a probability inference apparatus according to an embodiment;

FIG. 2A is a diagram illustrating a discrete probability distribution inferred by a probability inference apparatus, according to an embodiment;

FIG. 2B is a diagram illustrating a cumulative probability distribution inferred by a probability inference apparatus, according to an embodiment;

FIG. 2C is a diagram illustrating a process of calculating a cumulative probability distribution from a discrete probability distribution by a probability inference apparatus, according to an embodiment;

FIG. 3 is a diagram illustrating a training method of an additional layer, according to an embodiment;

FIG. 4 is a diagram illustrating a training method of a probability inference apparatus, according to an embodiment;

FIG. 5 is a block diagram of an encoding device according to an embodiment;

FIG. 6 is a block diagram of an encoding system according to an embodiment;

FIG. 7 is a block diagram of a decoding device according to an embodiment;

FIG. 8 is a block diagram of a decoding system according to an embodiment;

FIG. 9 is a diagram illustrating an example of a large-scale language model (LLM) including a probability inference apparatus, according to an embodiment; and

FIG. 10 is a flowchart illustrating a method of operating a probability inference apparatus, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

The embodiments described below may be applied to the design of a hardware-friendly neural network structure in various application fields, for example, where probability inference on data distribution is performed, such as data compression in various devices and/or systems. For example, the various devices and/or systems may include, but is not limited to, terminal devices, mobile application processors (APs), large-scale language models (LLMs) trained on large text data to perform natural language processing (NLP) tasks, and logical volume managers (LVMs), which are systems for efficiently managing disk space. Here, the data compression may correspond to context mixing-based data compression but is not necessarily limited thereto.

Hereinafter, the embodiments are described in detail with reference to the accompanying drawings. When describing the embodiments with reference to the accompanying drawings, like reference numerals refer to like components, and any repeated description related thereto will be omitted.

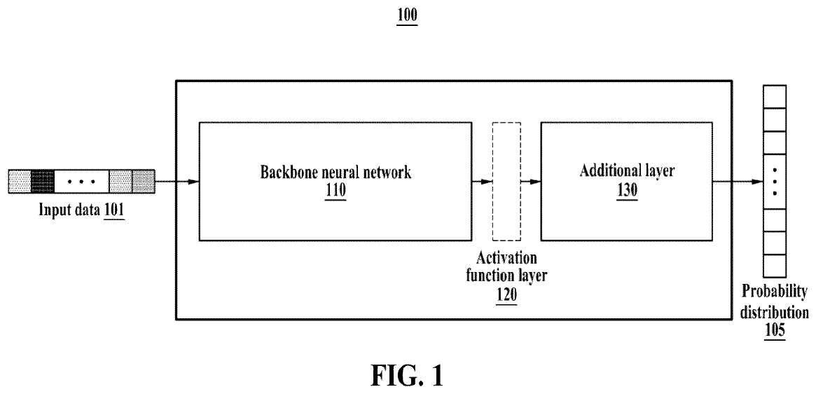

FIG. 1 is a block diagram illustrating a probability inference apparatus according to an embodiment. Referring to FIG. 1, a probability inference apparatus 100 according to an embodiment may include a backbone neural network 110 and an additional layer 130. The probability inference apparatus 100 may optionally further include an activation function layer 120.

The backbone neural network 110 may generate continuous output data corresponding to input data 101. The input data 101 may be various types of data that may be processed by the backbone neural network 110. For example, the input data 101 may include, but is not limited to, input vectors, input symbols, text, voice, and/or images. The backbone neural network 110 may be a neural network of various structures. The backbone neural network 110 may be, for example, one or a combination of a multi-layer perceptron (MLP), a convolutional neural network (CNN), a recurrent neural network (RNN), and a transformer but is not necessarily limited thereto.

The output data may include, but is not limited to, an output vector, a latent vector, a logit, and/or an output symbol output from the backbone neural network 110.

In an example case in which an activation function layer 120 that outputs only positive numbers (e.g., positive values) is arranged in the last layer of the backbone neural network 110, the probability inference apparatus 100 may infer a probability distribution 105 by arranging the additional layer 130 right after the backbone neural network 110. For example, the activation function layer 120 that outputs only positive numbers may include, but is not limited to, a rectified linear unit (ReLU) function.

In an example case in which an output value of the last layer of the backbone neural network 110 is not in a positive form, the probability inference apparatus 100 may arrange, for example, the activation function layer 120 including an activation function that always outputs positive numbers, such as the ReLU function, after the backbone neural network 110.

According to an embodiment, the activation function layer 120 may convert negative output data into positive output data. The activation function layer 120 may include, for example, a ReLU activation function that converts the negative output data into “0” and maintains the positive output data as it is. The probability inference apparatus 100 may convert the negative output data into the positive output data using the ReLU activation function. In addition, the probability inference apparatus 100 may convert the negative output data into the positive output data using various activation functions that remove negative numbers, such as, for example, a clipped ReLU function or a thresholded ReLU function.

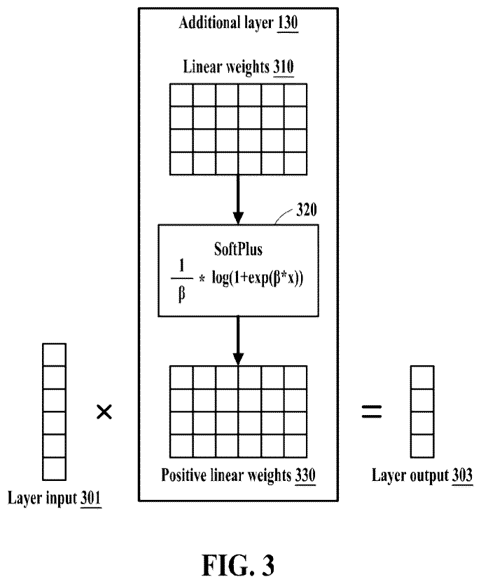

The additional layer 130 may include a layer that performs a multiply-accumulate (MAC) operation and a positive parameter. The positive parameter may be, for example, a linear parameter that is made positive by a SoftPlus activation function 320 in a training process shown in FIG. 3 below.

In an embodiment, probability values output by the additional layer 130 may have numerical approximate values less than or equal to a predetermined precision, which allows the probability inference apparatus 100 to be operable by an integer operation in an example case in which the probability inference apparatus 100 is implemented in hardware.

The additional layer 130 may be configured as a layer that performs a multiplication and accumulation (summation) operation, that is, the MAC operation. For example, the additional layer 130 may be a linear layer or a convolution layer.

The additional layer 130 may be, for example, a non-negative constrained layer in which a parameter is constrained to the positive parameter but is not necessarily limited thereto. Here, “parameters” may be values determined by the additional layer 130 and/or the backbone neural network 110 through training and may include, for example, a weight and/or a bias. The weight may determine connection strength between the input data 101 and a neuron. For each piece of input data 101, the weight may be multiplied and transmitted to neurons of the backbone neural network 110 and/or the additional layer 130. The bias may be a value for adjusting activation of each neuron. The bias may be added to the input data 101 multiplied by the weight. According to an embodiment, parameters may be optimized during the training process to improve prediction performance of the additional layer 130.

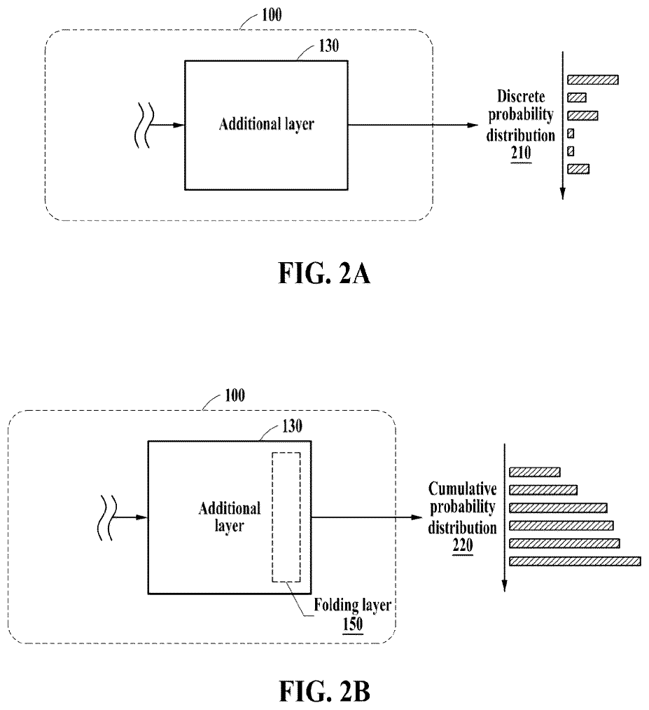

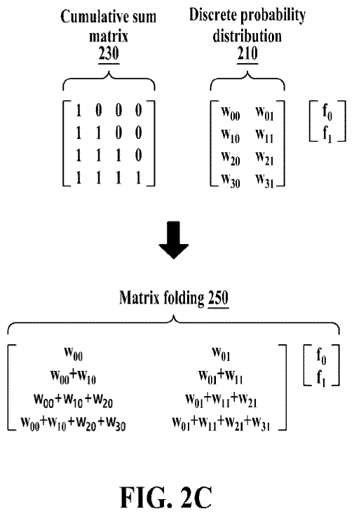

In an example case in which the output data of the backbone neural network 110 is positive output data, the additional layer 130 may infer the probability distribution 105 corresponding to the input data 101 by performing the MAC operation with the positive output data using the positive parameter. Here, the probability distribution 105 inferred by the probability inference apparatus 100 may include, for example, a discrete probability distribution in the form of a probability mass function (PMF), as shown in FIG. 2A, and/or a cumulative probability distribution in the form of a cumulative mass function (CMF), as shown in FIG. 2B. The PMF may be used to explicitly represent the probability for each value of a discrete probability variable. The sum of all values of the PMF may always be “1”. In an example case in which the probability distribution 105 inferred by the probability inference apparatus 100 is the cumulative probability distribution, the probability distribution 105 may represent a monotonically increasing form.

In an example case in which the output data of the backbone neural network 110 is negative output data, the probability inference apparatus 100 may convert the negative output data into positive output data by the activation function layer 120 and may then input the positive output data to the additional layer 130.

The additional layer 130 may be configured by the positive parameter, and since the values input from the backbone neural network 110 are also positive, the additional layer 130 may be a single neural network layer or a plurality of neural network layers that always outputs positive values. In this manner, the discrete probability distribution in the form of the PMF and the cumulative probability distribution in the form of the CMF are always positive.

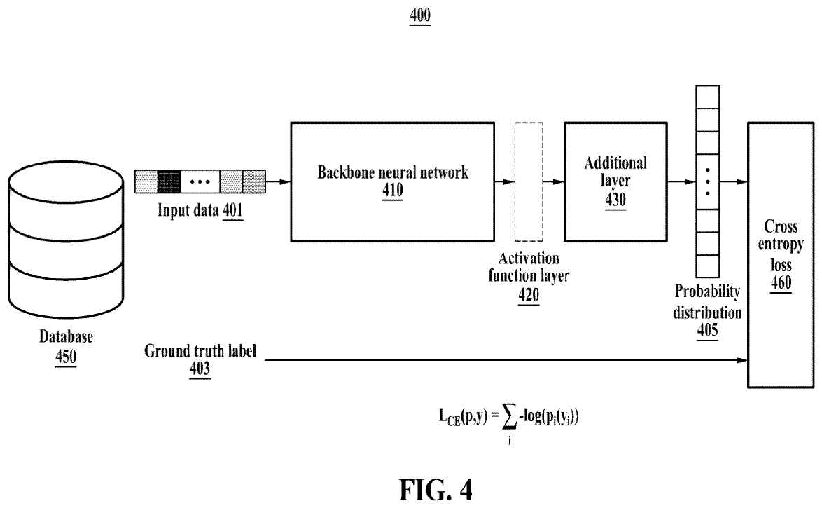

The additional layer 130 may be trained, for example, by a cross entropy loss (e.g., a cross entropy loss 460 of FIG. 4) based on a difference between the probability distribution 105 and a probability distribution of a ground truth label corresponding to the input data 101 but is not necessarily limited thereto. Here, the “cross entropy loss” may correspond to a loss function mainly used when solving a classification issue in machine learning or deep learning.

The training method of the additional layer 130 is described in more detail with reference to FIG. 3 below. In addition, the training method of the probability inference apparatus 100 is described in more detail with reference to FIG. 4 below.

According to an embodiment, the additional layer 130 may include a folding layer at an output end. The folding layer may output the cumulative probability distribution in which the discrete probability distribution is accumulated. For example, the folding layer may output the cumulative probability distribution, by reconstructing, through matrix folding, an operation result of a cumulative sum matrix and the discrete probability distribution inferred by the additional layer 130. Here, the matrix folding or layer folding may be a method of increasing efficiency of a neural network model by using a technique of reducing or transforming the dimension of a matrix in a neural network. The folding layer may reduce the amount of calculations by converting high-dimensional data into low-dimensional data through the matrix folding, thereby reducing complexity of the neural network and improving training speed as well. The method of calculating the cumulative probability distribution from the discrete probability distribution by the folding layer is described in more detail with reference to FIG. 2C below.

In an embodiment, by using the additional layer 130 that always outputs positive values, the probability inference apparatus 100, which is hardware-friendly, that may perform inference (or prediction) of the probability distribution 105 for the input data 101, without using a nonlinear activation function, may be provided. For example, the nonlinear activation function may include, but is not limited to, a softmax function or a sigmoid function. Here, “hardware-friendly” may be understood to mean that an operation that is easy to implement in hardware is performed, without using an operation that is difficult to implement in hardware (e.g. a softmax function operation and/or an exponentiation operation). For example, the operation that is easy to implement in hardware may include, but is not limited to, an addition operation (e.g., accumulation operation) and a multiplication operation, and an operation that is difficult to implement in hardware may include, but is not limited to, a softmax function operation and/or an exponentiation operation.

For example, the probability inference apparatus 100 may be configured without the nonlinear activation function, and each layer may be configured to perform only hardware-friendly multiplication and addition operations.

In an embodiment, by using a hardware-friendly neural network structure, the probability inference apparatus 100 may be configured as an application-specific integrated circuit (ASIC), thereby reducing power consumption as well. The probability inference apparatus 100 may also be referred to as a “probability inference neural network” or a “probability inference network”.

The probability inference apparatus 100 may generate continuous output data based on the input data 101 (e.g., an input vector) and a fixed parameter set and may be configured such that the output data approximates or directly expresses the discrete probability distribution in the form of the PMF and/or the cumulative probability distribution in the form of the CMF.

The probability inference apparatus 100 may be utilized in various memory controllers including, for example, a compression engine. The memory controller may be, for example, a memory controller for compute express link (CXL), dynamic random-access memory (DRAM), high bandwidth memory (HBM), and/or flash memory but is not necessarily limited thereto.

The probability inference apparatus 100 may have a memory expansion effect in various electronic products related to, but not limited to, DRAM, storage, and data transmission. For example, the various electronic products may include, but is not limited to, the mobile terminals, televisions, etc . . . . The probability inference apparatus 100 may be utilized in various application fields requiring discrete probability estimation, such as data compression, video codec, Internet of Things (IoT) sensors, and medical imaging. The probability inference apparatus 100 may have the memory expansion effect of DRAM and storage through lossless data compression, while also increasing a bandwidth through reducing the amount of data.

FIGS. 2A and 2B are diagrams illustrating a form of a probability distribution inferred by a probability inference apparatus, according to an embodiment, and FIG. 2C is a diagram illustrating a process of converting a discrete probability distribution into a cumulative probability distribution by the probability inference apparatus 100, according to an embodiment.

Referring to FIG. 2A, a discrete probability distribution 210 in the form of a PMF according to an embodiment is illustrated, and referring to FIG. 2B, a cumulative probability distribution 220 in the form of a CMF according to an embodiment is illustrated.

As described above, in an example case in which the last layer of a backbone neural network outputs only positive numbers, the probability inference apparatus 100 may infer the discrete probability distribution 210 in the form of the PMF, for example, as shown in FIG. 2A, by arranging the additional layer 130 right after the backbone neural network.

Furthermore, in some applications such as data compression, the probability inference apparatus 100 may need to directly infer the cumulative probability distribution 220 in the form of the CMF using input of an entropy encoder and/or an entropy decoder. In this case, the probability inference apparatus 100 may combine, in advance, a cumulative sum matrix 230 with the discrete probability distribution 210 inferred by the additional layer 130 and may then fold the result of the combining by a folding layer 150, as illustrated in FIG. 2C, thereby directly inferring the cumulative probability distribution 220, which is an accumulated form of the discrete probability distribution 210, without a separate cumulative sum operation.

As shown in FIG. 2C, the probability inference apparatus 100 may calculate the cumulative probability distribution 220 in which the discrete probability distribution 210 is accumulated, by reconstructing, through a matrix folding 250, an operation result between the discrete probability distribution 210 and the cumulative sum matrix 230. Here, the matrix folding 250 may be performed by the folding layer 150 arranged at an output end of the additional layer 130, as shown in FIG. 2B.

For example, the last layer of the additional layer 130 may include the folding layer 150 rather than an activation layer, and the folding layer 150 may include a linear or convolutional layer. Since the convolutional layer may also be interpreted as linear, a cumulative sum operation may be combined to the last layer of the additional layer 130, as shown in FIG. 2C. According to such an embodiment, PMF or CMF output may be achieved without structural changes in an additional layer.

In an example case in which the cumulative probability distribution 220 is required, the probability inference apparatus 100 may directly generate the discrete probability distribution 210 as the cumulative probability distribution 220 by the matrix folding 250.

The probability inference apparatus 100 may directly infer the discrete probability distribution 210 and/or the cumulative probability distribution 220 using only a multiplication operation and an accumulation operation and may structurally ensure that the cumulative probability distribution 220 satisfies monotonically increasing characteristics of the CMF. For example, the backbone neural network 110 of FIG. 1 may be designed to output positive values or may output the positive values by an activation function. Since an input of the additional layer 130 is positive and parameter (weight) values within the additional layer 130 are also positive, the additional layer 130 may be calculated as positive number (weight)×positive number (input)+positive number (bias). Accordingly, the additional layer 130 may be guaranteed to output a positive PMF, and the CMF, which is a cumulative sum of the positive PMF, may also be guaranteed to monotonically increase.

FIG. 3 is a diagram illustrating a training method of an additional layer, according to an embodiment. Referring to FIG. 3, a diagram of a training process of the additional layer 130 according to an embodiment is shown.

During the training process, positive output data of a backbone neural network may be input as a layer input 301 to the additional layer 130.

The additional layer 130 may obtain positive linear weights 330 by applying linear weights 310 to a SoftPlus activation function 320. Here, the linear weights 310 may be negative or positive numbers. The linear weights 310 may be used during the training process and may not be used during an inference process.

The SoftPlus activation function 320 may correspond to a function of converting a negative number to a positive number. The SoftPlus activation function 320 may be similar to a ReLU activation function or a rectifier but may provide a smoother output, that is, a gentle approximate value for a positive part of an input value x. The SoftPlus activation function 320 may be expressed, for example, as SoftPlus (x)=(1/β)*log (1+e^{(β*x)}). The soft plus function 320 may provide an output similar to the ReLU function for positive numbers with an input value (x) size greater than 0, but can exhibit a smoother change in which the slope of the output value continues gradually for negative numbers with an input value (x) size less than 0.

According to an embodiment, the probability inference apparatus 100 may use the positive linear weights 330, which are made positive by the SoftPlus activation function 320, as a positive parameter in the inference process. The positive linear weights 330 may be quantized. The probability inference apparatus may store and use the positive linear weights 330 with fixed weights in a buffer or memory, etc.

The additional layer 130 may perform a MAC operation between the positive output data of the backbone neural network and the positive linear weights 330, thereby inferring a probability distribution corresponding to input data and outputting the probability distribution as a layer output 303.

FIG. 4 is a diagram illustrating a training method of a probability inference apparatus, according to an embodiment. Referring to FIG. 4, according to an embodiment, a process of training a probability inference apparatus 400 using the cross entropy loss 460 is illustrated.

In the training process, the probability inference apparatus 400 may input input data 401 stored in a database 450 to a backbone neural network 410 to generate continuous output data. Here, the database 450 may store a ground truth label y 403 corresponding to the input data 401.

In an example case in which the output data is not positive output data (i.e., the output data is negative output data), the probability inference apparatus 400 may input the negative output data to an activation function layer 420 to convert the negative output data into positive output data. In an example case in which the output data is positive output data, the probability inference apparatus 400 may directly transmit the positive output data to an additional layer 430 without passing through the activation function layer 420.

The additional layer 430 may infer a probability distribution 405 (e.g., a discrete probability distribution in the form of a PMF) corresponding to input data by performing a MAC operation with the positive output data output by the backbone neural network 410 using a positive parameter. Here, as needed, the probability inference apparatus 400 may output a cumulative probability distribution in which the discrete probability distribution is accumulated, by reconstructing, through matrix folding of a folding layer, an operation result of a cumulative sum matrix and the discrete probability distribution inferred by the additional layer 430.

Here, the additional layer 430 may be trained by the cross entropy loss 460 based on a difference between the probability distribution 405 predicted by the probability inference apparatus 400 and a probability distribution of the ground truth label 403 corresponding to the input data x 401.

The cross entropy loss 460 may measure the difference between the probability distribution 405 predicted by the probability inference apparatus 400 and the probability distribution of the ground truth label 403. The cross entropy loss 460 may be expressed as Equation 1 below.

$${L}_{C E} ( p , y ) = {\sum }_{i} - log ( {p}_{i} ( {y}_{i} ) ) \qquad [ Equation 1 ]$$

Here, y may represent a ground truth label, p may represent a probability (or a probability distribution) predicted by the probability inference apparatus 400, and i is an integer. The ground truth label may have, for example, a value of 0 or 1 . . . .

The cross entropy loss 460 may measure an amount (or a level) of difference between the prediction of the probability inference apparatus 400 and an actual label, and the more accurate the prediction of the probability inference apparatus 400, the smaller a loss value, in other words, a value of the cross entropy loss 460.

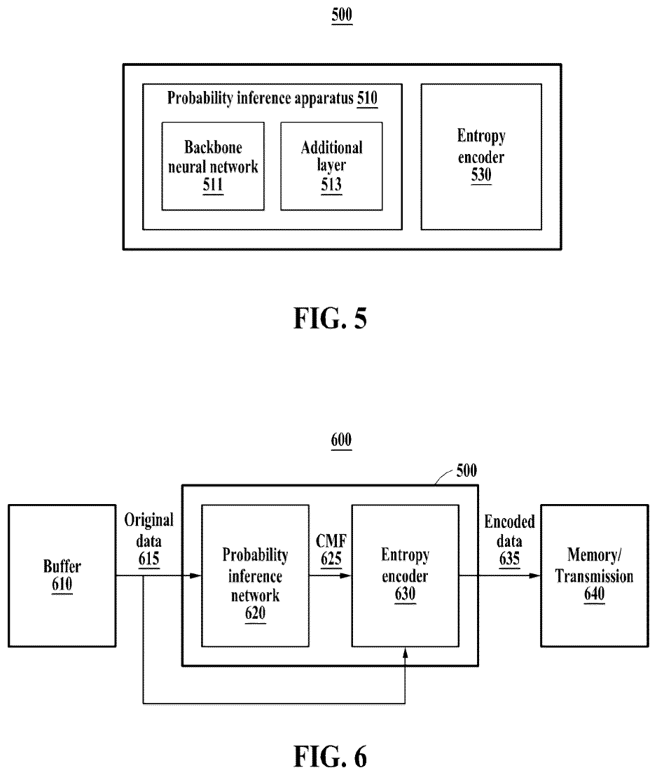

FIG. 5 is a block diagram of an encoding device according to an embodiment. Referring to FIG. 5, an encoding device 500 according to an embodiment may include a probability inference apparatus 510 and an entropy encoder 530. The probability inference apparatus 510 may be, for example, the probability inference apparatus 100 described above with reference to FIG. 1 but is not necessarily limited thereto.

The probability inference apparatus 510 may infer a cumulative probability distribution corresponding to an input symbol of a current point in time. The probability inference apparatus 510 may include a backbone neural network 511 and an additional layer 513.

The backbone neural network 511 may generate continuous output data corresponding to the input symbol of the current point in time.

The additional layer 513 may include a layer for performing a MAC operation and a positive parameter. In an example case in which the output data is positive output data, the additional layer 513 may infer a discrete probability distribution corresponding to the input symbol of the current point in time by performing the MAC operation with the positive output data using the positive parameter.

According to an embodiment, in an example case in which the output data is negative output data, the probability inference apparatus 510 may generate the positive output data corresponding to the negative output data by an activation function layer.

According to an embodiment, the additional layer 513 may include a folding layer. For example, the folding layer may output the cumulative probability distribution, in which the discrete probability distribution is accumulated, by matrix folding an operation result of the discrete probability distribution and a cumulative sum matrix.

The entropy encoder 530 may entropy encode the input symbol by the cumulative probability distribution inferred by the probability inference apparatus 510 and may convert the input symbol into a bitstream.

The entropy encoder 530 may encode the input symbol by adjusting the length of a code representing the input symbol according to an occurrence probability of the input symbol, that is, the cumulative probability distribution inferred by the probability inference apparatus 510. The entropy encoder 530 may encode a frequently occurring symbol in the cumulative probability distribution with a short code and a rarely occurring symbol with a long code, thereby reducing the average code length of data and improving compression efficiency. According to an embodiment, a symbol that occurs more than a reference number may be identified as a frequently occurring symbol and a symbol that occurs less than a reference number may be identified as a rarely occurring symbol.

Unlike related art probability inference networks that use softmax or exponential operations, the probability inference apparatus 510 according to an embodiment may perform sum and multiplication operations that are easy to implement in hardware and may directly infer the cumulative probability distribution in the form of a CMF without a separate cumulative sum operator, thereby reducing area and power consumption. Accordingly, the probability inference apparatus 510 may be utilized in resource-constrained environments, such as edge devices, mobile chipsets, and ASIC-based inference engines, and may also be utilized in compression engines within memory controllers.

The encoding device 500 may process (e.g., encode) video data, such as a video including a plurality of frames, a single image, or a moving image, and transmit the processed video data to an external device. For example, the encoding device 500 may be an electronic device, such as a content-providing device that provides video content, a video broadcasting device, or a terminal that transmits video in a video call or video conference but is not necessarily limited thereto. The encoding device 500 may encode (or compress) all or at least a portion of the image data to generate encoded data with a reduced data size, thereby reducing the amount of image data to be transmitted and increasing the transmission speed.

The encoding device 500 may include a neural encoder that performs an encoding process of compressing input image data to generate a latent vector and/or a bit stream but is not necessarily limited thereto.

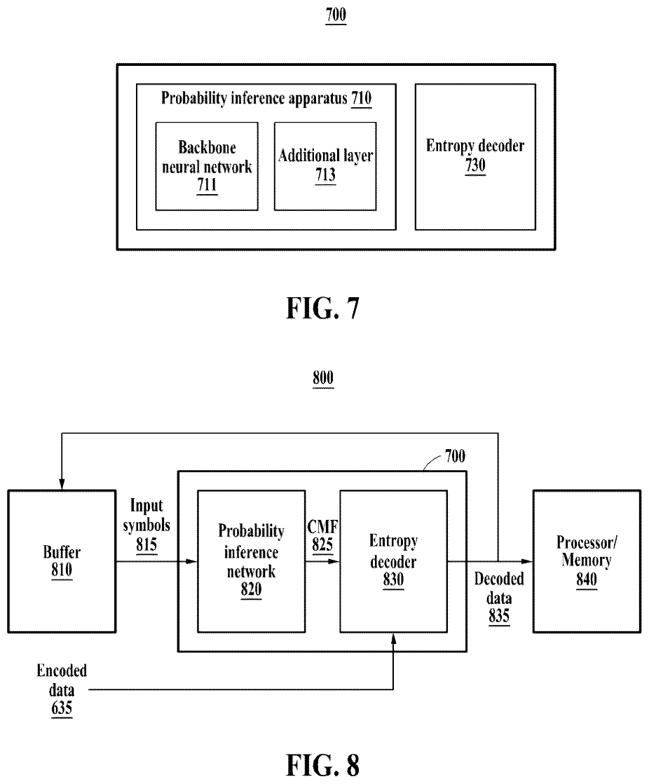

According to an embodiment, image data (e.g., compressed image data) processed by the encoding device 500 may be transmitted (or delivered) to a decoding device (e.g., a decoding device 700 of FIG. 7) via a network. In embodiments, the image data transmitted from the encoding device 500 to the decoding device may be feature information (e.g., a feature map, a latent vector, and/or a bit stream) extracted from original image data through an encoding process, but is not necessarily limited thereto.

Here, the network may include, but is not limited to, a wired network of a cable network, a short-range wireless network, or a long-range wireless network. The short-range wireless network may include, for example, Bluetooth™, wireless fidelity (Wi-Fi), and infrared data association (IrDA). The long-range wireless network may include a legacy cellular network, a 3G/4G/5G network, a next-generation communication network, the Internet, and/or a computer network (e.g., a local area network (LAN) or a wide area network (WAN)).

FIG. 6 is a block diagram of an encoding system according to an embodiment. Referring to FIG. 6, a configuration of an encoding system 600 according to an embodiment is illustrated.

The encoding system 600 may include a buffer 610, a probability inference network 620, an entropy encoder 630, and/or a memory 640. However, the disclosure is not limited thereto, and as such, the encoding system 600 may include one or more other components. The probability inference network 620 and the entropy encoder 630 may correspond to, for example, the encoding device 500 described above but are not necessarily limited thereto.

As described above, probability inference may be used for data compression, but the disclosure is not limited thereto. The encoding system 600 may infer a cumulative probability distribution in the form of a CMF of a symbol to be compressed at a current point in time by using symbols of a previous point in time as context when performing context-based data compression.

The buffer 610 may store original data 615 to be compressed. The original data 615 may be, for example, the symbol to be compressed at the current point in time.

The original data 615 stored in the buffer 610 may be input to the probability inference network 620 and the entropy encoder 630.

The probability inference network 620 may infer a probability distribution (e.g., a cumulative probability distribution 625 in the form of a CMF) corresponding to input data by performing a MAC operation with continuous output data corresponding to the original data 615. The probability inference network 620 may be, for example, the probability inference apparatus 100 shown in FIG. 1, but the disclosure is not necessarily limited thereto.

The entropy encoder 630 may convert encoded data 635 into a bitstream by entropy encoding the symbol to be compressed at the current point in time using the cumulative probability distribution 625 in the form of the CMF. Here, the cumulative probability distribution 625 in the form of the CMF may correspond to an occurrence probability of each input symbol.

The encoding system 600 may store the encoded data 635, that is, the bitstream, in the memory 640 and/or may transmit the encoded data 635 to the memory 640.

FIG. 7 is a block diagram of a decoding device according to an embodiment. Referring to FIG. 7, the decoding device 700 according to an embodiment may include a probability inference apparatus 710 and an entropy decoder 730.

The probability inference apparatus 710 may infer a cumulative probability distribution corresponding to an input symbol of a current point in time based on a decoded input symbol of a previous point in time. The probability inference apparatus 710 may include a backbone neural network 711 and an additional layer 713.

The backbone neural network 711 may generate continuous output data corresponding to an input symbol of a point in time before decoding.

The additional layer 713 may include a layer for performing a MAC operation and a positive parameter. In an example case in which the output data is positive output data, the additional layer 713 may infer a discrete probability distribution corresponding to the input symbol of the current point in time by performing the MAC operation with the positive output data using the positive parameter. In an example case in which the output data is negative output data, the probability inference apparatus 710 may further include an activation function layer for generating the positive output data corresponding to the negative output data.

According to an embodiment, the additional layer 713 may include a folding layer. For example, the folding layer included in the additional layer 713 may output the cumulative probability distribution, in which the discrete probability distribution corresponding to the input symbol of the current point in time is accumulated, by matrix folding an operation result of the discrete probability distribution corresponding to the input symbol of the current point in time and a cumulative sum matrix.

The entropy decoder 730 may entropy decode the bitstream transmitted from the transmission side (the encoding device side) using the cumulative probability distribution inferred by the probability inference apparatus 710 and may restore the bitstream to the input symbol of the current point in time. Here, the bitstream may include an encoded input symbol of the current point in time.

The entropy decoder 730 may restore compressed data to an original form through the entropy encoding. The entropy decoder 730 may interpret encoded data according to an occurrence probability of each input symbol and may reconstruct an original input symbol. The entropy decoder 730 may decompress data losslessly by using a reverse process of the encoding method used in the entropy encoding.

The decoding device 700 may receive image data (or encoded feature information) encoded by an encoding device (e.g., the encoding device 500 of FIG. 5) via a network. In an embodiment, encoded image data generated by the encoding device may be transmitted to the decoding device 700 directly via the network or via one or more other devices. The decoding device 700 may be implemented in various forms of electronic devices. The decoding device 700 may include, for example, a portable communication device (e.g., a smartphone), a computing device, a portable multimedia device (e.g., a tablet personal computer), a camera, a wearable device, a set-top box, a video streaming device, a content storage device, or a home appliance (e.g., a television). An electronic device according to embodiments of the present disclosure is not limited to the devices described above.

The decoding device 700 may process encoded image data to provide video to a user. For example, the decoding device 700 may decode encoded image data and provide reconstructed image data to the user. Through encoding performed by the encoding device, the data size of the original image data may be reduced, but some information included in the original image data may be lost during the encoding process. The decoding device 700 may reconstruct information lost during the encoding process of image data through decoding, thereby generating image data with higher image quality than the encoded image data.

The decoding device 700 may include, but is not limited to, a neural network-based neural decoder that performs a decoding process to reconstruct features lost during the encoding process by restoring (or decompressing) encoded (or compressed) image data. The neural network may refer to a model in which artificial neurons (or nodes), forming a network through synaptic connections, acquire problem-solving capabilities by adjusting the strength of the synaptic connections through training or machine learning. Artificial neurons of the neural network may include a combination of weights and/or biases, and the neural network may include one or more layers each including a plurality of artificial neurons.

FIG. 8 is a block diagram of a decoding system according to an embodiment. Referring to FIG. 8, a configuration of a decoding system 800 according to an embodiment is illustrated.

The decoding system 800 may include a buffer 810, a probability inference network 820, an entropy decoder 830, and a memory 840. However, the disclosure is not limited thereto, and as such, the decoding system 800 may include one or more other components according to an embodiment. The probability inference network 820 and the entropy decoder 830 may correspond to, for example, the decoding device 700 described above with reference to FIG. 7 but are not necessarily limited thereto.

The decoding system 800 may infer a cumulative probability distribution 825 in the form of a CMF for all symbols of a current point in time by utilizing input symbols 815 of a previous point in time that are decoded (decompressed) and may input the cumulative probability distribution 825 in the form of the CMF to the entropy decoder 830 together with the encoded data 635 to restore decoded data 835. The encoded data 635 may correspond to an encoded (compressed) input symbol. The decoded data 835 may correspond to an input symbol of the current point in time.

The buffer 810 may store input symbols and the input symbols 815 of the previous point in time decoded by the entropy decoder 830. Here, the decoded data 835 output from the entropy decoder 830 may be stored in the buffer 810 as the input symbols 815 of a point in time before restoring.

The probability inference network 820 may infer the cumulative probability distribution 825 in the form of the CMF for all input symbols of the current point in time, based on the input symbols 815 of a point in time before decoding. The probability inference network 820 may be, for example, the probability inference apparatus 100 shown in FIG. 1 but is not necessarily limited thereto.

The entropy decoder 830 may entropy decode a bitstream including the encoded data 635 of the current point in time using the cumulative probability distribution 825 in the form of the CMF to restore the input symbol of the current point in time. Here, the cumulative probability distribution 825 in the form of the CMF may correspond to an occurrence probability of each input symbol.

The decoding system 800 may store the decoded data 835, that is, the restored input symbol of the current point in time, in the memory 840 and/or may transmit the decoded data 835 to the memory 840.

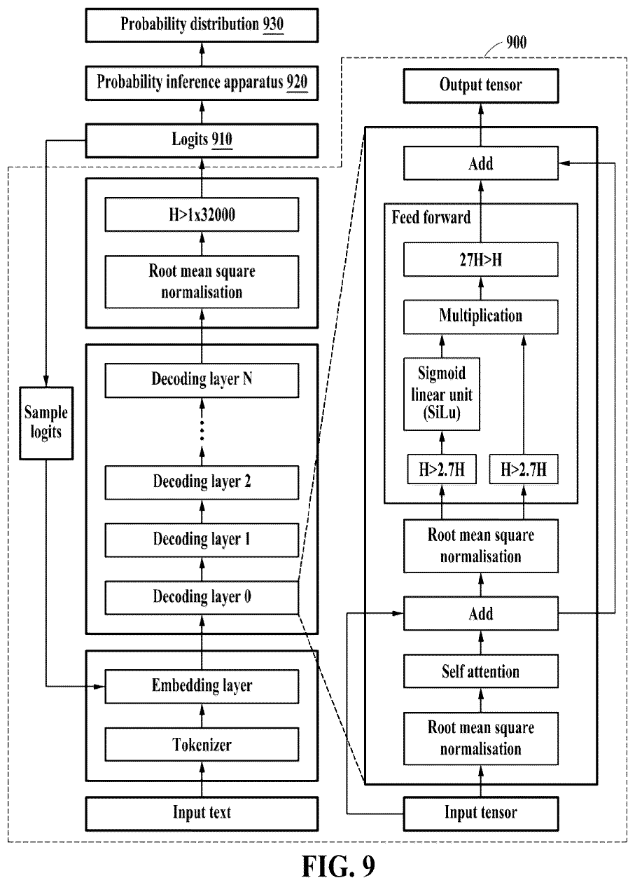

FIG. 9 is a diagram illustrating an example of a large-scale language model (LLM) including a probability inference apparatus, according to an embodiment. Referring to FIG. 9, according to an embodiment, a diagram illustrating a method of applying the probability inference apparatus to an on-device LLM 900 is shown.

For example, in a lightweight model such as the on-device LLM 900, which processes and trains data directly on the device without using a cloud server, replacing a softmax function having high operation cost would be beneficial.

In an embodiment, weight reduction of the on-device LLM 900 may be possible by replacing the softmax function through a MAC operation-based neural network (e.g., a probability inference apparatus 920) that uses only a positive value.

In a training operation, the probability inference apparatus 920 may perform knowledge distillation from the on-device LLM 900 by utilizing a corresponding neural network structure without the softmax function. In an inference operation, the probability inference apparatus 920 may effectively predict a probability distribution 930 of a next token by logits 910 output from the on-device LLM 900 using only hardware-friendly MAC operations, without exponential operations or large-capacity look-up tables (LUTs) The probability distribution 930 may be a discrete probability distribution in the form of a PMF and/or a cumulative probability distribution in the form of a CMF.

In addition, by inferring the probability distribution 930 by the hardware-friendly MAC operations, the probability inference apparatus 920 may allow ultra-low latency processing and onboard computing in application fields such as recognition of objects (e.g., pedestrians, vehicles, and road signs) around a vehicle, prediction of lane (or path) changes of a vehicle, collision prediction, risk estimation (probabilistic risk map), and action planning in highway/urban situations in advanced driver-assistance systems (ADAS) and/or autonomous driving systems of automobiles.

According to an embodiment, an action policy may be established by inferring the probability for fast decision-making through optimized area efficiency utilizing the probability inference apparatus 920, which is hardware-friendly. In addition, according to an embodiment, the cumulative probability distribution in the form of the CMF may be directly inferred by the probability inference apparatus 920, and a comparison operation between the inferred cumulative probability distribution and a specific threshold may be performed in a simple and quick manner (e.g., less complexity and increased speed).

In addition, the probability inference apparatus 920 may also be utilized in systems with limited hardware resources. In general, a neural processing unit (NPU) may perform MAC operations, and a complex non-linear operation such as a softmax operation may be performed in an operation module such as a digital signal processor (DSP). Here, a DSP module for the softmax operation used in an operation of a final probability value may occupy a predetermined area in hardware despite low utilization. In an embodiment, a probability value or a probability distribution value may be inferred without the softmax operation, and thus, modules such as DSPs with low utilization may be eliminated to infer the probability value even in situations where operation resources are limited, such as NPUs.

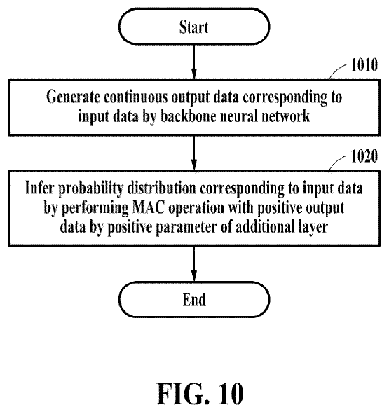

FIG. 10 is a flowchart illustrating a method of operating a probability inference apparatus, according to an embodiment. Operations to be described hereinafter may be performed sequentially but not necessarily. For example, the order of the operations may change and at least two of the operations may be performed in parallel.

Referring to FIG. 10, a probability inference apparatus according to an embodiment may infer a probability distribution corresponding to input data in operations 1010 and 1020.

In operation 1010, the method according to an embodiment may include generating continuous output data corresponding to input data by a backbone neural network. For example, a probability inference apparatus (according to an embodiment of the disclosure) may generate continuous output data corresponding to input data by a backbone neural network. The input data may be in various forms that the backbone neural network may process, such as input vectors, input symbols, text, speech, and images.

For example, the backbone neural network may include, but is not limited to, a CNN, a an RNN, a perceptron, a multilayer perceptron, a feed forward (FF) network, a radial basis function (RBF) network, a deep feed forward (DFF) network, a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), a transformer, and an attention network (AN). A neural network may generally refer to a model having a problem-solving ability implemented through artificial neurons (or nodes) forming a network through synaptic connections where the strength of the synaptic connections is changed through training or machine learning. The artificial neurons of the backbone neural network may include a combination of weights and/or biases. The backbone neural network may include one or more layers including a plurality of artificial neurons.

The output data may be output vectors, latency vectors, logits, and/or output symbols output to the backbone neural network but is not necessarily limited thereto.

According to an embodiment, the probability inference apparatus may convert the output data into positive output data. The probability inference apparatus may convert, for example, output data into positive output data using a ReLU activation function that converts negative output data into “0” and maintains the positive output data as it is. In addition, the probability inference apparatus may convert the output data into the positive output data using various activation functions that remove negative numbers, such as a clipped ReLU or a thresholded ReLU.

In operation 1020, the method according to an embodiment may include inferring the probability distribution corresponding to the input data by performing a MAC operation with the positive output data by a positive parameter of an additional layer. For example, the probability inference apparatus may infer the probability distribution corresponding to the input data by performing a MAC operation with the positive output data by a positive parameter of an additional layer. The probability distribution inferred by the probability inference apparatus may be at least one of a discrete probability distribution in the form of a PMF and a cumulative probability distribution in the form of a CMF.

The probability inference apparatus may calculate, for example, the cumulative probability distribution in which the discrete probability distribution is accumulated, by reconstructing, through matrix folding, an operation result of a cumulative sum matrix and the discrete probability distribution inferred by the additional layer. Here, the additional layer may be trained by cross entropy loss based on a difference between the probability distribution and the ground truth label (ground truth probability distribution) corresponding to the input data.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, a field-programmable gate array (FPGA), a programmable logic unit (PLU), a microprocessor, a logic circuit, a processing circuit, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored permanently or temporarily in any type of machine, component, physical or virtual equipment, computer storage medium, or device capable of providing instructions or data to or being interpreted by the processing device. The software also may be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of performing probability inference, the method comprising:
receiving input data;
generating, using a backbone neural network, continuous output data based on the input data;
performing a multiply-accumulate (MAC) operation on positive output data of the backbone neural network using a positive parameter of an additional layer; and
inferring a probability distribution corresponding to the input data based on a result of the MAC operation.

2. The method of claim 1, further comprising:
converting output data of the backbone neural network into the positive output data.

3. The method of claim 1, wherein
the probability distribution comprises at least one of a discrete probability distribution in a form of a probability mass function (PMF) and a cumulative probability distribution in a form of a cumulative mass function (CMF).

4. The method of claim 1, further comprising:
obtaining a cumulative probability distribution in which a discrete probability distribution is accumulated by reconstructing, through matrix folding, an operation result of a cumulative sum matrix and the discrete probability distribution inferred by the additional layer.

5. The method of claim 1, further comprising:
training the additional layer by a cross entropy loss based on a difference between the probability distribution and a probability distribution of a ground truth label corresponding to the input data.

6. The method of claim 1, wherein
the backbone neural network comprises any one of a multilayer perceptron (MLP), a convolutional neural network (CNN), a recurrent neural network (RNN), and a transformer.

7. The method of claim 1, wherein
the additional layer comprises a non-negative constrained layer in which a parameter is constrained to the positive parameter.

8. The method of claim 3, wherein,
in a case in which the probability distribution is the cumulative probability distribution, the probability distribution represents a monotonically increasing form.

9. The method of claim 1, wherein
the positive parameter is a linear parameter that is made positive by a SoftPlus activation function in a training process.

10. The method of claim 4, further comprising:
obtaining an entropy-encoded input symbol by entropy encoding an input symbol of a current point in time using the cumulative probability distribution; and
converting the entropy-encoded input symbol into a bitstream.

11. The method of claim 4, further comprising:
restoring an input symbol of a current point in time by entropy decoding a bitstream including an encoded input symbol of the current point in time using the cumulative probability distribution,
wherein the input data comprises a decoded input symbol of a previous point in time, and the cumulative probability distribution represents all input symbols of the current point in time.

12. A probability inference apparatus comprising:
at least one memory; and
at least one processor configured to:
receive input data;
generate, using a backbone neural network, continuous output data based on the input data;
perform a multiply-accumulate (MAC) operation on positive output data of the backbone neural network using a positive parameter of an additional layer; and
infer a probability distribution corresponding to the input data based on a result of the MAC operation,
wherein the at least one memory is configured to store a parameter of the backbone neural network and the positive parameter of the additional layer.

13. The probability inference apparatus of claim 12, wherein
the at least one processor is further configured to convert output data of the backbone neural network into the positive output data.

14. The probability inference apparatus of claim 12, wherein
the at least one processor is further configured to obtain a cumulative probability distribution in which the discrete probability distribution is accumulated by reconstructing, through matrix folding, an operation result of a cumulative sum matrix and the discrete probability distribution inferred by the additional layer.

15. The probability inference apparatus of claim 14, wherein
the at least one processor is further configured to convert an input symbol of a current point in time into a bitstream by entropy encoding the input symbol of the current point in time using the cumulative probability distribution.

16. The probability inference apparatus of claim 14, wherein
the at least one processor is further configured to restore an input symbol of a current point in time by entropy decoding a bitstream including an encoded input symbol of the current point in time using the cumulative probability distribution,
wherein the input data comprises a decoded input symbol of a previous point in time, and the cumulative probability distribution represents all input symbols of the current point in time.

17. A non-transitory computer-readable storage medium storing instructions that, when executed by a processor, cause the processor to perform:
receiving input data; generating, using a backbone neural network, continuous output data based on the input data; and
performing a multiply-accumulate (MAC) operation on positive output data of the backbone neural network using a positive parameter of an additional layer; and
inferring a probability distribution corresponding to the input data based on a result of the MAC operation.

18. The non-transitory computer-readable storage medium of claim 17, storing instructions that, when executed by the processor, cause the processor to further perform:
converting output data of the backbone neural network into the positive output data.

19. The non-transitory computer-readable storage medium of claim 17, storing instructions that, when executed by the processor, cause the processor to further perform:
obtaining a cumulative probability distribution in which the discrete probability distribution is accumulated by reconstructing, through matrix folding, an operation result of a cumulative sum matrix and the discrete probability distribution inferred by the additional layer.

20. The non-transitory computer-readable storage medium of claim 17, wherein
the additional layer comprises a non-negative constrained layer in which a parameter is constrained to the positive parameter.
